(19) United States
(12) Patent Application Publication
(10) Pub. No.: US 2003/0061090 A1
(43) Pub. Date: Mar. 27, 2003

(54) Method, apparatus, system and user interface for scheduling tasks

(75) Inventor: Howard T. Marano, Malvern, PA (US)

Correspondence Address: Elsa Keller, Legal Assistant, Intellectual Property Department, SIEMENS CORPORATION, 186 Wood Avenue South, Iselin, NJ, 08830, US

(73) Assignee: Siemens Medical Solution Health Services Corporation

(21) Appl. No.: 10/007,370

(22) Filed: Feb. 19, 2002

Related U.S. Application Data
(60) Provisional application No. 60/297,958, filed on Jun. 13, 2001.

(51) Int. Cl. G06F 17/60

(52) U.S. Cl. 705/9

(57) ABSTRACT

The present inventions comprise a system and method for assigning an identifier to at least one of a plurality of displayable task schedules associated with a corresponding plurality of different entities, the identifier representing a task requiring action by an entity. In an exemplary embodiment, the system comprises a display processor for initiating display of at least one interface menu to support a user's entry of decision information for assigning a task representative identifier to a task schedule associated with a particular entity; an interface processor for receiving decision information entered via the interface menu; and a decision processor for applying the received decision information in assigning the task representative identifier to the task schedule associated with the particular entity in response to a predetermined event. In an exemplary method of the present inventions for assigning an identifier to at least one of a plurality of displayable task schedules associated with a corresponding plurality of different entities where the identifier represents a task requiring action by an entity, an exemplary method comprises the steps of initiating display of at least one interface menu supporting user entry of decision information for assigning a task representative identifier to a task schedule associated with a particular entity; receiving decision information entered via the at least one interface menu; and applying the received decision information in assigning the task representative identifier to the task schedule associated with the particular entity in response to a predetermined event. It is emphasized that this abstract is provided to comply with the rules requiring an abstract which will allow a searcher or other reader to quickly ascertain the subject matter of the technical disclosure. It is submitted with the understanding that it will not be used to interpret or limit the scope of meaning of the claims.

### PRIORITY

This application claims priority through U.S. Provisional Application No. 60/297,958 filed Jun. 13, 2001 for “A System And User Interface For Scheduling Tasks.”

### BACKGROUND OF THE INVENTION

The present invention relates to project management systems in general, and to providing users of a system such as a project management or workflow system with one or more “to do” lists or work lists at a specified event occurrence such as when that user logs in to the system. Many project management and workflow management systems exist in the prior art, including systems and methods for performing flexible workflow process execution in a distributed workflow management system. These workflow process management systems operate on one or more of the computers to control the computer network in executing the workflow process. In many systems, a task performer may be notified of the task to be done using a communications medium designated for that task performer, usually e-mail.

Other systems have been proposed, such as for sales forces, technician forces, or hospital staffing, where events that require the attention of one or more personnel may arise randomly and those personnel require notification. In these prior art solutions, an exemplary method of notification is to have an event manager notify a back office system which in turn may automatically generate an notice such as an order or a task.

There is a need to be able to provide one or more work lists to each user or entity when a user logs in to a scheduling or workflow system the schedule may be tailored to a user, a group or category of users, or an entire entity.

### SUMMARY

The present inventions comprise a system and method for assigning an identifier to at least one of a plurality of displayable task schedules associated with a corresponding plurality of different entities, the identifier representing a task requiring action by an entity. In an exemplary embodiment, the system comprises a display processor for initiating display of at least one interface menu to support a user's entry of decision information for assigning a task representative identifier to a task schedule associated with a particular entity; an interface processor for receiving decision information entered via the interface menu; and a decision processor for applying the received decision information in assigning the task representative identifier to the task schedule associated with the particular entity in response to a predetermined event.

An exemplary method of the present inventions comprises a method for assigning an identifier to at least one of a plurality of displayable task schedules associated with a corresponding plurality of different entities where the identifier represents a task requiring action by an entity. The exemplary method comprises the steps of initiating display of at least one interface menu supporting user entry of decision information for assigning a task representative identifier to a task schedule associated with a particular entity; receiving decision information entered via the at least one interface menu; and applying the received decision information in assigning the task representative identifier to the task schedule associated with the particular entity in response to a predetermined event.

The scope of protection is not limited by the summary of an exemplary embodiment set out above, but is only limited by the claims.

### BRIEF DESCRIPTION OF THE DRAWINGS

These and other features, aspects, and advantages of the present invention will become more fully apparent from the following description, appended claims, and accompanying drawings in which:

FIG. 1 is a schematic of an exemplary system embodiment;

FIG. 2 is an exemplary interface menu used for decision data entry;

FIG. 3 is an exemplary template maintenance display;

FIG. 4 is an exemplary login and overview display;

FIG. 5 is an exemplary work list selection display;

FIG. 6 is a flowchart of an exemplary embodiment of a work list creation; and

FIG. 7 is a flowchart of an exemplary embodiment of user display of a work list.

### DETAILED DESCRIPTION OF THE PREFERRED EMBODIMENT

In general, throughout this description, if an item is described as implemented in software, it can equally well be implemented as hardware. Further, as used herein, “user” and “entity” are understood to comprise a individual user, a group or category of users, a role or characteristic of one or more users, and a particular device or system such as a medical device or system.

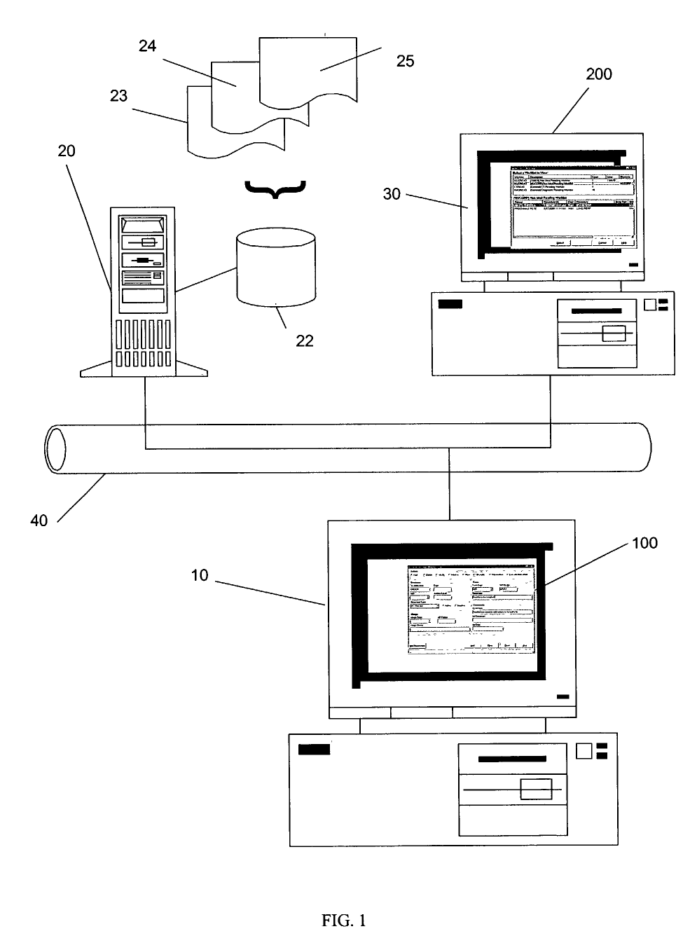

The present inventions may be used to allow a user to control the entries included on a displayable work list or task schedule (generally referred to herein by the numeral “1” and shown in FIG. 1 as “5”). Control of the entries may be accomplished such as by using industry standard SQL and TransSQL commands to define decision logic and stored procedures to execute the decision logic against a relational database. In the present inventions, work lists to be updated may be selected based on a general work list name, the role of a user, or a specific user identifier, and one or more maintenance tools may be present to allow a system administrator to create and maintain the decision logic and assignment rules.

Referring generally to FIG. 1, a schematic overview of an exemplary system, users may login or otherwise access a system interface, such as display processor 10, to develop and assign task schedules. Users may also be informed of the schedule of tasks assigned to that user. In an embodiment, the present inventions will assign an identifier to at least one of a plurality of displayable task schedules to be associated with a corresponding plurality of different users. Each identifier may represent one or more tasks requiring action by the user.

As will be familiar to those of ordinary skill in object oriented programming arts, events can programmatically trigger a stored procedure. These triggering events may invoke one or more logical procedures, optionally passing parameterized data to one or more of those procedures. In response to the invocation, the procedures may process data such as data in one or more tables of one or more databases. By way of example and not limitation, using such triggers events associated with a work list may be inserted, deleted, or updated automatically during run time.

Accordingly, the present inventions may use any database-resident data to decide for which work list an entry will be inserted, deleted, or updated. In a preferred embodiment, industry standard or vendor supplied languages and database stored procedures may be used to implement the decision logic, by way of example and not limitation including decisions on what work list to insert, delete, or update an entry. By way of example and not limitation, TransAct SQL is a language compatible with American National Standards Institute (ANSI SQL). TransAct SQL includes proprietary extensions of the SQL syntax that may be used to provide use of software environment-specific commands to define the desired actions, by way of example and not limitation including environment specific ASSIGN, STATUS, and DELETE commands. Additionally, end users may be allowed to create their own work lists without requiring customization or tailoring of the underlying product source code.

Display processor 10, interface processor 20, and decision processor 30 may be different computers such as those shown in FIG. 1 interconnected by a data communications interface such as local area network 40, or may be processes executing in one or more computers such as a plurality of processes executing in interface processor 20.

Database 22 comprises one or more tables and related documents, e.g. 23, 24, 25. Work list table 23 comprises records containing specific work data in one or more fields. One or more of these fields may allow differentiation between one or more types of work lists 1. Worklist table 23 may be dynamic. In a preferred embodiment, work list table 23 provides one or more fields to contain a mnemonic and description for each work list defined by a user with permission to define work lists. A maintenance function may also exist, executing such as in interface processor 20, to maintain data in work list table 23.

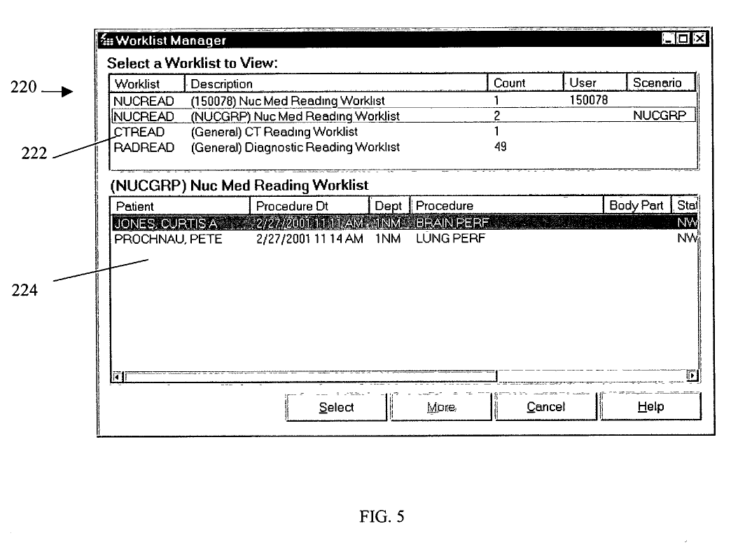

One or more decision documents 24 may further be present. Decision documents 24 may comprise commands used to determine one or more predetermined parameters for work lists, by way of example and not limitation comprising an identity of a work list to which the current entry should be added, what status should be assigned to the current entry on specific work list(s) 1, and from which work list(s) 1 the current entry should be deleted (an exemplary work list 1 is shown as 5 in FIG. 1 and as 204 in FIG. 5). Stored procedure 25, which may be generated when document 24 is initialized, may comprise one or more parameters, by way of example and not limitation comprising a first parameter reflecting an internal number for the current entry and a second parameter reflecting a table type mnemonic which specifies what kind of internal number is being passed in the first parameter.

Documents such as document 24 may further contain executable or interpreted code as well as user commands. By way of example and not limitation, in a preferred embodiment, these user commands may further comprise commands for a specific user's work list, for a group work list, and for a general work list. By way of further example and not limitation, a command for a specific user's work list may be used to assign the current entry to a work list, e.g. “ASSIGN USER “WorklistName” “UserName” [“Priority”].” In a similar fashion, group assignment may be obtained, e.g. “ASSIGN GROUP “WorklistName” “ScenarioId” [“Priority”],” as well general assignment, e.g. “ASSIGN GENERAL “WorklistName” [“Priority”].” In these examples, “WorklistName” is the name of a specific work list, “UserName” is a valid username, “Scenariold” is a valid scenario identifier or user class identifier, and “Priority” is a numeric priority assigned to the entry on the work list, as these terms will be familiar to those of ordinary skill in the computer arts.

Status of a current entry on a work list may also be updated, e.g. “STATUS USER “WorklistName” “UserName” “StatusCd,” “STATUS GROUP “WorklistName” “Scenariold” “StatusCd,” or “STATUS GENERAL “WorklistName” “StatusCd”” commands where “WorklistName” is the name of the work list; “StatusCd” is a status code to assign, e.g. active, new, held, or lock; “UserName” is a valid usemname; and “Scenariold” is a valid scenario identifier or user class identifier, as these terms will be familiar to those of ordinary skill in the computer arts.

A third type of command may be used to delete the current entry from a work list, e.g. DELETE USER “WorklistName” “UserName”, DELETE GROUP “WorklistName” “Scenariold”, or DELETE GENERAL “WorklistName”.

In additionally envisioned embodiments, changes may be tracked, such as with a tracking maintenance function. One or more character fields may be added to one or more tables in database 22. In a preferred embodiment, these fields may accept a list of work list names comprising a plurality of work list names. The list may be in an appropriate format such as a comma-delimited file. In an exemplary embodiment, a first field may contain work lists to which the current entry will be added and a second field may contain work lists from which the current entry will be removed. Additional fields may be present as well, such as a field to accept a document mnemonic to allow for more sophisticated work list maintenance such as assigning the current entry to a specific user or group of users, or assigning a higher priority to the current entry, or deleting the current entry from one or more work lists under certain conditions.

User event maintenance functions may also be provided, in an exemplary embodiment such as with one or more additional fields in one or more tables 23, 24, 25. These user event maintenance fields may accept a list of work list names, e.g. a comma-delimited file, and comprise a first field describing work lists to which the current entry will be added and a second field describing work lists from which the current entry will be removed. Additional fields may be present as well, such as a field to accept a document mnemonic to allow for more sophisticated work list maintenance such as assigning the current entry to a specific user or group of users, assigning a higher priority to the current entry, or deleting the current entry from one or more work lists under certain conditions.

In a preferred embodiment, each time an scheduled outcome is tracked to a new tracking step or when an event mnemonic is logged, data in predetermined fields such as those above may be evaluated to determine whether any work list maintenance is necessary.

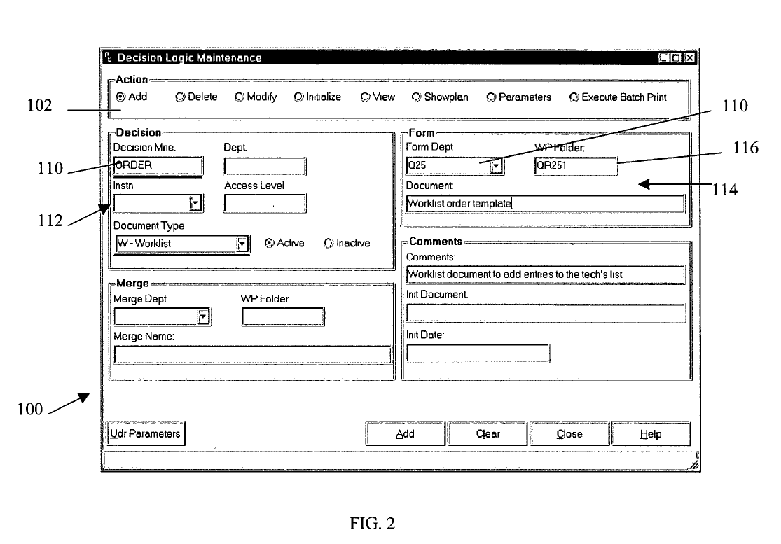

Referring now to FIG. 2, an exemplary interface menu, in an exemplary embodiment a user with appropriate access initiates display of at least one interface menu 100. Interface menu 100 supports entry of decision information by the user for assigning a task representative identifier to a task schedule associated with a particular entity such as that user or other entity. As shown in FIG. 2, in this exemplary embodiment interface menu 100 allows a user with appropriate access to add, delete, and modify decision information such as with action choices 102. Action choices 102 may comprise additional decision manipulation options, by way of example and not limitation allowing for parameters to be assigned that define a predetermined event to trigger application of the decision information in assigning the task representative identifier to the task schedule.

Additionally, fields, generally referred to herein and in FIG. 2 as “110,” may be present by which the user can more fully define the task information when assigning a task representative identifier such as at 112 to a particular entity such as at 114. Fields 110 may comprise a source of the decision information and/or decision information comprising a procedure for processing data associated with a task to determine a task schedule for listing the task representative identifier. These may be associated automatically with one or more fields 110, e.g. decision mnemonic field 111. Accordingly, the decision information may comprises one or more logical procedures to be executed to process data associated with a task, including identifying a task schedule for incorporating the task representative identifier. These abilities are more fully described below.

For systems comprising the present inventions in which a plurality of entities exist for which work lists 1 and schedules will be created and maintained, an identifier may be assigned to one or more task schedules associated with the corresponding plurality of different entities.

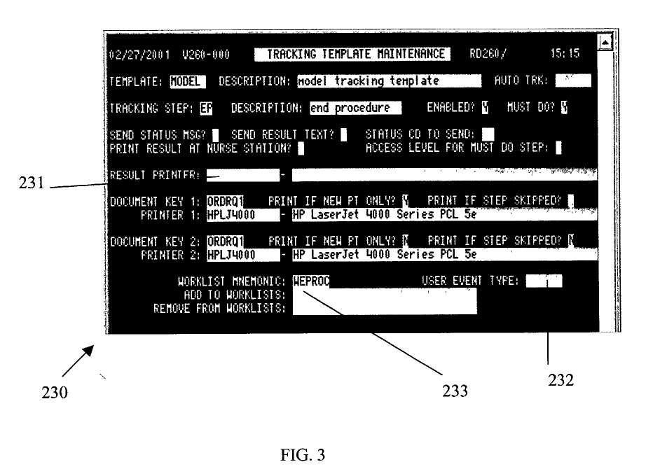

Referring now to FIG. 3, an exemplary maintenance form, work lists 1 may be maintained such as in a tracking module having an interface form 230 such as at interface processor 20. At each tracking step, a user with appropriate system permissions may define whether a procedure should be added to one or more work lists 1 and/or whether a procedure should be removed from one or more work lists 1. Documents 24 may also exist to allow the user to define which username or class of user will be assigned to a work list 1.

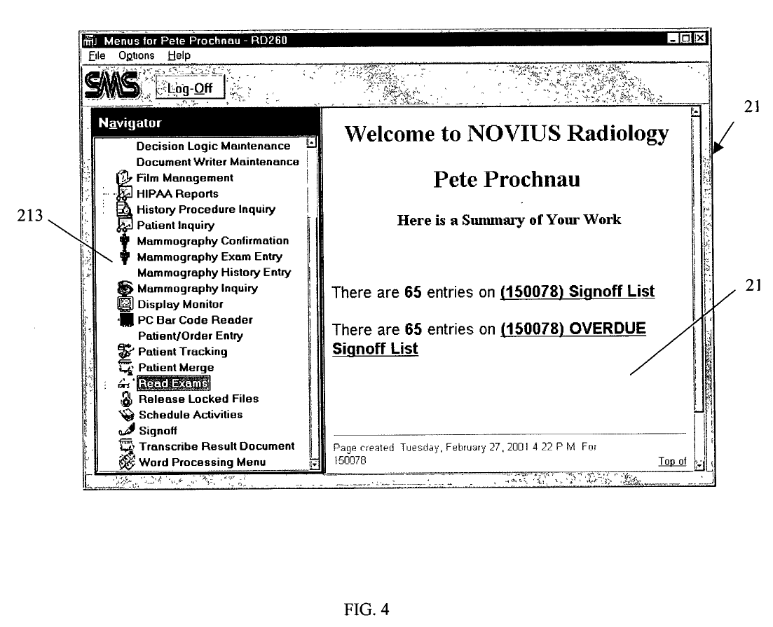

Referring now to FIG. 4, an exemplary login screen, and FIG. 5, an exemplary work list display, upon login to the system, a user may be presented with work list overview 210. In this exemplary embodiment, work list overview 210 comprises a navigation portion 213 and a work list summary 214. Upon selection of a class of work lists, e.g. “Read Exams,” work list 220 (FIG. 4) may appear. The user can then select from one or more classes, shown at 222 (FIG. 4) whereby a work list 1 for that user will be presented, such as at 224 (FIG. 4).

In some software environments, software applications need to be able to be “driven” by work lists 1. In the prior art, a user must somehow know what work needs to be done and then identify the work to an appropriate software application, by way of example such as via a barcode or choosing a applicable option from a menu. In systems comprising the present invention, work lists 1 may trigger the appropriate software application. By way of example and not limitation, a work list manager may exist and display the relevant work lists 1 to which the user has access such as at 222. For example, if the user is a transcriptionist, they will have access to transcription work lists 1 but not other work lists 1. When a desired software application is launched, the user will be able to choose the correct work list 1, and the appropriate entry on that work list 1, and begin work immediately.

In addition to being able to choose from a work list 1, systems comprising the present inventions may provide a “Next Entry” capability that allows the user to go to the next entry on the work list 1 directly, without ever having to choose explicitly.

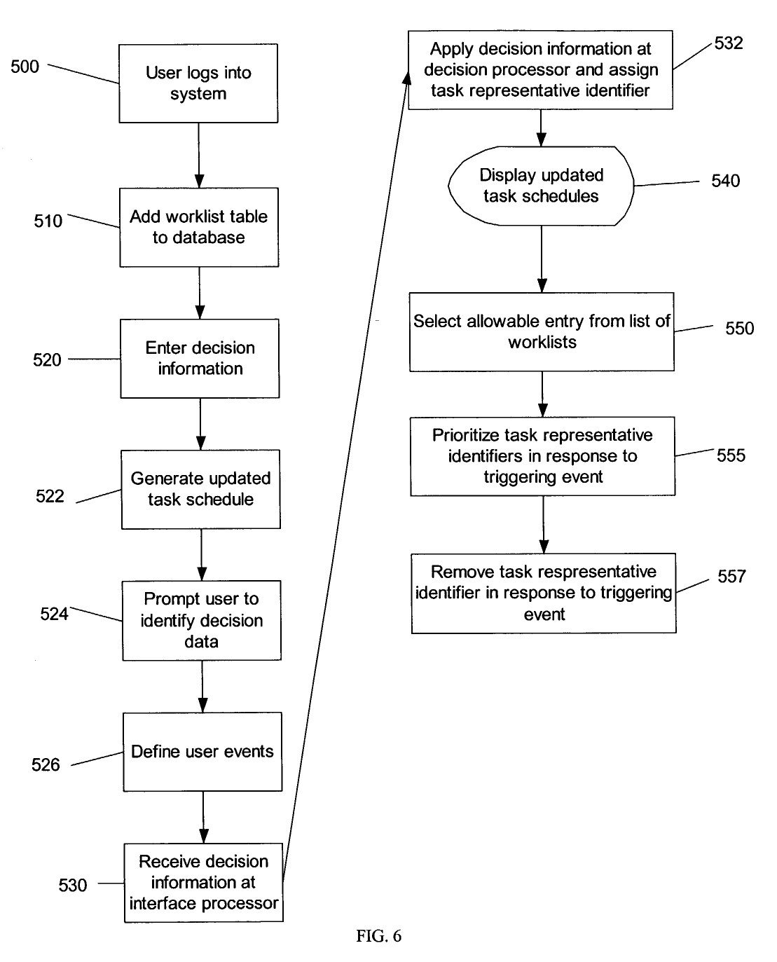

In the operation of an exemplary embodiment, referring now to FIG. 6, a flowchart of an exemplary embodiment, a user logins into the system 500. Users with adequate permission will be able to define work list(s) 1 that are appropriate for an entity's needs. In an exemplary embodiment, work list table 23 is added 510 to database 22. Records in work list table 23 comprise a plurality of fields, by way of example not limitation comprising a name field, a responsible user or class of users field (i.e., technologist or radiologist), and a key value field used to identify the work that must be done.

Decision information such as entered as from interface menu 100 (FIG. 2) is received and applied 520 in assigning a task representative identifier to the task schedule associated with the particular entity in response to occurrence of the triggering event. Similarly, as described herein above, an updated task schedule may be generated 522 in response to applying received decision information in assigning the task representative identifier to the task schedule associated with the particular entity in response to occurrence of a predetermined event.

Decision information may comprise one or more logical procedures for processing data associated with a task to identify a task schedule for incorporating the task representative identifier. A logical procedure may condition allocation of the task to a task schedule associated with a particular entity upon one or more occurrences of a phenomenon which may or may not be coincident. For example, it may be desirable to programmatically condition assigning a subsequent task to a user or entity based on what also has or is happening as indicated by a response entered into the same or another worksheet 1. Thus, phenomena may include user initiated events such as selecting an option on a menu or system triggered events such as a programmatically triggered response to the presence of a code or other entry on a worksheet 1.

By way of further example, in a medical context a routine mammography screening may occur, and, upon obtaining the results, a radiologist may recommend that a more detailed ultrasound follow-up occur. The radiologist may use the system of the present inventions to create an entry on an appropriate entity's “to be scheduled” worklist, including the radiologist's own worklist, such as by using a menu option. The menu option may allow the radiologist to mark an examination entry to show that the more detailed followup examination is needed. However, the system may also programmatically schedule such an event if a certain code is entered by or for the radiologist upon completion of the analysis of the results, i.e. the results code could act as a triggering event to schedule the more detailed ultrasound.

In a similar manner, a triggering event may be dependent on one or more occurrences of such phenomena which may or may not be coincident. For allocations requiring a plurality of coincident occurrences, the logical procedure or triggering event may invoke one or more procedures to acquire data relevant to identify the coincidence of the plurality of occurrences or may undertake the determination itself.

Once interface menu 100 (FIG. 2) is displayed, the user may be prompted 524 to identify decision data. These may include (1) a predetermined event to trigger application of the decision information in assigning the task representative identifier to the task schedule, (2) a source of the decision information, (3) decision information comprising a procedure for processing data associated with a task to determine a task schedule for listing the task representative identifier, or (4) a combination thereof. User events may also be defined 526 for work lists 1. Referring additionally to FIG. 2 and FIG. 3, numerous options may be associated with each work list 1 entry type, by way of example and not limitation including options to modify or configure behavior such as default printers and the like.

Referring additionally to FIG. 2 and FIG. 3, at each tracking step, a user with appropriate system permissions may define whether a procedure should be added to one or more work lists 1 and/or whether a procedure should be removed from one or more work list 1. Documents 24 may also exist, to allow the user to define which username or class of user will be assigned to a work list 1. For example, again using a medical context, perhaps Dr. Jones is the Radiologist who protocols all spiral CT exams. When a spinal CT is ordered, that exam will be added to Dr. Jones' protocol work list 1, and at the same time, can be added to a CT technologist work list 1 of exams to be performed on the day for which it was ordered. When Dr. Jones protocols the exam, it would be removed from his work list 1. When the exam is tracked to the Begin Procedure step, it can be removed from the technologist work list 1.

After decision information data are entered such as via interface menu 100 (FIG. 2), interface processor 20 (FIG. 1) then receives decision information for processing 530. After processing, decision processor 30 applies the received decision information 532 in assigning a task representative identifier to the task schedule associated with the particular entity in response to a predetermined event.

An updated task schedule for the selected entity may then be displayed 540 where the updated task schedule is generated in response to applying received decision information in assigning the task representative identifier to the task schedule associated with the particular entity, such as in response to occurrence of a triggering event. Similarly, the task representative identifier may be selectively assigned to at least one of the plurality of task schedules associated with the corresponding plurality of different entities in response to occurrence of the triggering event.

For systems comprising a plurality of entities, interface menu 100 may be used to view and select 550 an allowable entry from a list of work list 1 entries. As shown in FIG. 4 and FIG. 5, in an exemplary medical embodiment these data may comprise a medical procedure identifier for a scheduled procedure, a time and date of performance of a medical procedure, patient medical record information, location of performance of a medical procedure, patient type identifier, patient physical characteristics, or a combination thereof. Further, in this exemplary medical embodiment, the decision information may identify a predetermined event which corresponds patient admission, beginning of a medical procedure, end of a medical procedure, user defined events based on information acquired, and the like, or combinations thereof.

Once decision information is received, a plurality of the task representative identifiers for a task schedule associated with the entity may be prioritized 555 in response to a triggering event. Additionally, the task representative identifier may be removed from the task schedule associated with the particular entity in response to occurrence of a triggering event 557.

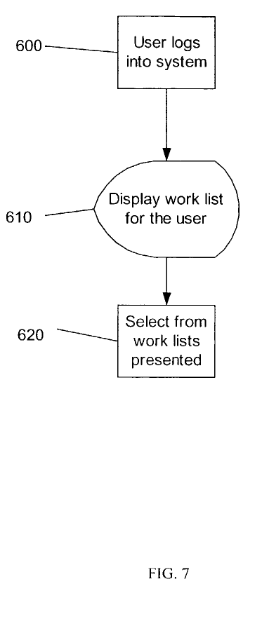

Referring now to FIG. 7 and FIG. 4, after work list 1 is created, in a preferred embodiment after a user logs in 600 to a system comprising the present inventions, e.g. such as at decision processor 30, the user may be presented 610 with a summary, e.g. 210 (FIG. 4) of their work schedule. Such a summary may include any work lists 1 that exist for them and a count of how many items exist on that work list 1. The user may then be able to select a specific work list 620 and launch into the appropriate application to do their work. By way of example and not limitation, for an exemplary system in a radiology department, a reading (or interpretation) work list for a radiologist may launch into a “read exam” function in interpretation mode whereas a “redo work list” for a transcriptionist may launch into a “transcribe results” function and a “protocol work list” launch into “read exam” function in a protocol mode.

It will be understood that various changes in the details, materials, and arrangements of the parts which have been described and illustrated above in order to explain the nature of this invention may be made by those skilled in the art without departing from the principle and scope of the invention as recited in the following claims.

What is claimed is:

1) A method for assigning an identifier to at least one of a plurality of displayable task schedules associated with a corresponding plurality of different entities, the identifier representing a task requiring action by an entity, comprising:
a. initiating display of at least one interface menu supporting user entry of decision information for assigning a task representative identifier to a task schedule associated with a particular entity;
b. receiving decision information entered via the at least one interface menu; and
c. applying the received decision information in assigning the task representative identifier to the task schedule associated with the particular entity in response to a predetermined event.

2) A method according to claim 1, wherein the step of initiating display of the at least one interface menu includes initiating display of menu elements prompting a user to identify at least one of (a) the predetermined event triggering application of the decision information in assigning the task representative identifier to the task schedule, (b) a source of the decision information, (c) decision information comprising a procedure for processing data associated with a task to determine a task schedule for listing the task representative identifier.

3) A method according to claim 1, wherein the decision information comprises a logical procedure for processing data associated with a task to identify a task schedule for incorporating the task representative identifier.

4) A method according to claim 3, wherein the data associated with a task comprises at least one of (a) a medical procedure identifier for a scheduled procedure, (b) a time and date of performance of a medical procedure, (c) patient medical record information, (d) location of performance of a medical procedure, (e) patient type identifier and (f) patient physical characteristics.

5) A method according to claim 1, wherein the entity comprises at least one of (a) a user, (b) a category of users, (c) a role of a user and (d) a medical device or system.

6) A method according to claim 1, wherein:
a. the decision information identifies the predetermined event and
b. the predetermined event corresponds to at least one of (a) patient admission, (b) beginning of a medical procedure, (c) end of a medical procedure and (d) a user defined event based on information acquired.

7) A method according to claim 1, further including applying the received decision information in prioritizing a plurality of task representative identifiers of a task schedule associated with a particular entity in response to occurrence of a triggering event.

8) A method for assigning an identifier to at least one of a plurality of task schedules associated with a corresponding plurality of different entities, the identifier representing a task requiring action by an entity, comprising:
a. initiating display of at least one interface menu supporting user entry of decision information for assigning a task representative identifier to a task schedule associated with a particular entity and accessible by the particular entity, the decision information including:
i. a procedure for processing data associated with a task to identify a task schedule for incorporating the task representative identifier, and
ii. an event for triggering application of the procedure in allocating the task representative identifier to the identified task schedule;
b. receiving decision information entered via the at least one interface menu; and
c. applying the received decision information in assigning the task representative identifier to the task schedule associated with the particular entity in response to occurrence of the triggering event.

9) A method according to claim 8, wherein the data associated with a task comprises at least one of (a) a medical procedure identifier for a scheduled procedure, (b) a time and date of performance of a medical procedure, (c) patient medical record information, (d) location of performance of a medical procedure, (e) patient type identifier and (f) patient physical characteristics.

10) A method according to claim 8, wherein the triggering event corresponds to at least one of (a) patient admission, (b) beginning of a medical procedure, (c) end of a medical procedure and (d) a user defined event based on acquired information.

11) A method according to claim 8 further including acquiring the data associated with a task.

12) A method according to claim 8, wherein
a. the procedure conditions allocation of the task to the task schedule associated with the particular entity upon coincidence of a plurality of occurrences, and
b. further including acquiring data to identify the coincidence of the plurality of occurrences.

13) A method according to claim 8, wherein
a. the triggering event is conditioned upon coincidence of a plurality of occurrences, and
b. further including acquiring data to identify the coincidence of the plurality of circumstances.

14) A method according to claim 8, further including applying the received decision information in removing a task representative identifier from the task schedule associated with the particular entity in response to occurrence of a triggering event.

15) A method for providing a user interface for assigning an identifier to at least one of a plurality of displayable task schedules associated with a corresponding plurality of different entities, the identifier representing a task requiring action by an entity, comprising:
a. in response to a user command,
i. initiating display of at least one interface menu supporting user entry of decision information for assigning a task representative identifier to a task schedule associated with a particular entity; and
ii. initiating display of an updated task schedule associated with the particular entity, the updated task schedule being generated in response to applying received decision information in assigning the task representative identifier to the task schedule associated with the particular entity in response to occurrence of a predetermined event.

16) A method for providing a user interface supporting assigning an identifier to at least one of a plurality of task schedules associated with a corresponding plurality of different entities, the identifier representing a task requiring action by an entity, comprising:
a. in response to a user command,
i. initiating display of at least one interface menu supporting user entry of decision information for assigning a task representative identifier to a task schedule associated with a particular entity and accessible by the particular entity, the decision information including,
ii. a procedure for processing data associated with a task to identify a task schedule for incorporating the task representative identifier, and
iii. an event for triggering application of the procedure in allocating the task representative identifier to the identified task schedule; and
b. initiating display of an updated task schedule associated with the particular entity, the updated task schedule being generated in response to applying received decision information in assigning the task representative identifier to the task schedule associated with the particular entity in response to occurrence of the triggering event.

17) A method for assigning an identifier to at least one of a plurality of task schedules associated with a corresponding plurality of different entities, the identifier representing a task requiring action by an entity, comprising:
a. initiating display of at least one interface menu supporting user entry of decision information for selectively assigning a task representative identifier to at least one of a plurality of task schedules associated with a corresponding plurality of different entities, the decision information comprising:
i. a. procedure for processing data associated with a task to identify a task schedule for incorporating the task representative identifier, and
ii. an event for triggering application of the procedure in allocating the task representative identifier to the identified task schedule;
b. receiving decision information entered via the at least one interface menu; and
c. applying the received decision information in selectively assigning the task representative identifier to the at least one of the plurality of task schedules associated with the corresponding plurality of different entities in response to occurrence of the triggering event.

18) A system for assigning an identifier to at least one of a plurality of displayable task schedules associated with a corresponding plurality of different entities, the identifier representing a task requiring action by an entity, comprising:
a. a display processor for initiating display of at least one interface menu supporting user entry of decision information for assigning a task representative identifier to a task schedule associated with a particular entity;
b. an interface processor for receiving decision information entered via the at least one interface menu; and
c. a decision processor for applying the received decision information in assigning the task representative identifier to the task schedule associated with the particular entity in response to a predetermined event.

19) A computer program embodied within a computer-readable medium created using the method of claim 1.
